(19) United States
(12) Patent Application Publication
(10) Pub. No.: US 2012/0090932 A1
(43) Pub. Date: Apr. 19, 2012

(54) DAMPER

(76) Inventor: Zhifang Liu, Fujian (CN)

(21) Appl. No.: 13/380,016

(22) PCT Filed: Oct. 28, 2009
(86) PCT No.: PCT/CN2009/074646

§ 371 Date: Dec. 21, 2011

(51) Int. Cl. F16F 9/14

(52) U.S. Cl. 188/290

(57) ABSTRACT

A damper includes a rotary shaft, a sleeve, damping oil, and the damping oil is filled in a closed chamber formed between the rotary shaft and the sleeve; cooperating grooves are formed on the rotary shaft; partition parts are formed between the two cooperating grooves; oil passing holes provided on the partition parts are communicated with the two cooperating grooves; the oil passing holes are controlled by the check valves to make the damping oil flow in a single direction between the two cooperating grooves; the rotary shaft passing through the cooperating hole on the necking stop wall of the sleeve is connected by a connection member; two spacers are integrated with the sleeve; the height of the spacers locating in the cooperating grooves just fits in with the depth of the cooperating groove; an oil passing gap formed between the rotary shaft and the sleeve and is variable.

### BACKGROUND OF THE INVENTION

1. Field of the Invention

The present invention relates to a damper for an opening-closing device, and in particular relates to a damper providing without damping effect when the opening-closing device is opened and providing a damping effect when the opening-closing device is closed, capable of preventing collisions and damages.

2. Description of the Related Art

Dampers have been widely applied to various covers which are capable of being opened and closed, generally providing a one-way damping effect for an objects, such as a toilet cover plate. The damping effect of the damper is not occurred while opening the toilet cover plate, and the damping effect of the damper is occurred whiel closing the toilet cover plate, such that the toilet cover plate can be slowly dropped without collision to the nearby parts of the toilet.

In conventional toilet damping slowly-lowering mechanisms, a one-way blade for opening and closing oil way is utilized to block the one-way flow of the damping oil, thereby realizing a one-way damping effect. However, because of manufacturing errors and deformations formed between the one-way blade and the housing connected therewith, the oil way cannot be completely blocked by the one-way blade and thus the damping effect is lessened. In view of this, several damper or damping mechanisms are provided for improving the damping effects, but they are provided for the toilet covers which are made of plastic material and limited to rated weights. With the increasing standards of living and requirement, bathroom facilities made by different materials are needed to be provided, such as toilet cover plates made of wooden materials or other materials with sense of reality and thus obtaining increased weight thereof. Taking the more heavy-weight of toilet cover plates or some other piano keyboard covers for example, due to the space limitation on the tail portions of these cover plates or covers, the dampers or damping mechanisms for these cover plates or covers cannot be made at a large size, and therefore the area size of the oil tank and pressure application are limited thereto, resulting in poor damping effect.

### BRIEF SUMMARY OF THE INVENTION

In view of this, the present invention provides a damper capable of offering excellent damping effects to cover plates with different large weights.

To fulfill these purposes above, the present invention provides the technical measures as follows.

A damper comprises a rotary shaft, a sleeve, a damping oil, and a connection member connecting the rotary shaft and the sleeve. The damping oil is filled in a closed chamber formed between the rotary shaft and the sleeve. Two cooperating grooves are symmetrically formed on the rotary shaft, two partition parts are formed between the two cooperating grooves, each of the partition parts comprises a root providing an oil passing hole communicated with the two cooperating grooves, the oil passing hole of the partition part is controlled by a check valve so as to make the damping oil flow in a single direction between the two cooperating grooves, the rotary shaft comprises an inner end passed through a cooperating hole formed on a necking stop wall located in the sleeve and connected by the connection member, the sleeve comprises an inner wall integrally formed with two centrally-extended spacers, the height of the spacer and the depth of the cooperating groove do match so that the spacers are respectively located in the cooperating grooves, and an oil passing gap formed between the rotary shaft and the sleeve is variable followed by a mutual rotation of the rotary shaft and the sleeve.

The check valve is a movable oil-way plugging head disposed in a longitudinally-formed inner chamber of the partition part, and the inner chamber of the partition part comprises an opening at one side thereof communicated with the cooperating grooves.

The damper further comprises a friction plugging head disposed in the inner chamber of the partition part and a spring disposed between the movable oil-way plugging head and the friction plugging head, the movable oil-way plugging head is engaged to the oil passing hole of the partition part, and the friction plugging head is contacted by an end surface of the necking stop wall located in the sleeve.

The connection member comprises a seal retaining ring, a nut pressed against the seal retaining ring, and a sleeve-fixing element fixed on the sleeve, the nut is engaged to the rotary shaft passed through the cooperating hole of the sleeve, a plurality of toothed ribs being arranged finely and closely are connected between the sleeve-fixing element and the sleeve, a special-shaped fitting part disposed outside the rotary shaft is utilized to engage to a cover plate, a flange disposed next to the special-shaped fitting part is utilized to engage with a sealing member so that the flange and the sleeve are sealingly fitted by the sealing member therebetween, and the two symmetrically-formed cooperating grooves are disposed next to the flange and extended toward a front part of the rotary shaft.

The root of each of the partition parts includes a concave groove communicated with the neighboring oil passing hole of one of the two partition parts, and an opening of the concave groove is about half the size of a bottom width of the cooperating groove.

The movable oil-way plugging head is a spheroid.

The movable oil-way plugging head is a block including one end formed with a plane surface and the other end formed with an arc surface.

The friction plugging head is a block including one end formed with a plane surface and the other end formed with an arc surface.

The friction plugging head comprises a plane surface contacted by the end surface of the necking stop wall located in the sleeve.

The friction plugging head comprises a arc surface contacted by the end surface of the necking stop wall located in the sleeve.

In the above-described technical measures of the present invention, the check valves control the damping oil to flow in a single direction between the two cooperating grooves, capable of effectively regulating the oil passing gap formed between the rotary shaft and the sleeve and attaining the damping effect to slowly lower the cover plate. Further, in the opening structure of the check valve for controlling the oil passing hole, the damping effect can be achieved without increasing the volume of the oil tank, thereby simplifying and minimizing the structure of the damper, realizing the damping effect of large-sized cover plate in the dropping process, and attaining the slow-flowing effect or even deferring the slow-flowing time of the cover plate to avoid collisions.

Additionally, with the installation of the friction plugging head to be contacted by the end surface of the necking stop wall located in the sleeve, it can be appreciated that a damping device is further provided in the dampers or damping mechanisms, i.e., the friction force between the friction plugging head and the end surface of the necking stop wall is formed, thereby increasing the slowly-lowering damping effect to the cover plate.

Moreover, with the screwing engagement of the thread of the front end of the rotary shaft and the nut fixed by the sleeve-fixing element, when the rotary shaft is rotated relative to the sleeve, the rotary shaft functioned by the threads can be forwardly and backwardly moved in the sleeve to control the size of the oil passing gap, capable of simplifying the structure of the damper and providing the damping effect as requirements.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective exploded view of a damper of the present invention;

FIG. 2-1 is a partially-assembled sectional view of a damper of the present invention;

FIG. 2-2 is a side schematic view of a rotary shaft of a damper of the present invention;

FIG. 2-3 is a side schematic view of a sleeve of a damper of the present invention;

FIG. 2-4 shows a sectional schematic view of a combination of a rotary shaft and a sleeve of a damper of the present invention;

FIG. 2-5 is an assembled perspective sectional view of a damper of the present invention;

FIG. 2-6 is an assembled sectional view of a damper of the present invention;

FIG. 3-1 is a side view showing a first condition of a damper of the present invention for a toilet cover plate;

FIG. 3-2 is a perspective schematic view showing a first condition of a damper of the present invention for a toilet cover plate;

FIG. 3-3 is a side schematic view showing a first condition of a rotary shaft of a damper of the present invention for a toilet cover plate;

FIG. 3-4 is a side schematic view showing a first condition of a sleeve of a damper of the present invention for a toilet cover plate;

FIG. 3-5 is a sectional schematic view showing a first condition of a combination of a rotary shaft and a sleeve of a damper of the present invention for a toilet cover plate;

FIG. 3-6 is a partially-assembled sectional view showing a first condition of a damper of the present invention for a toilet cover plate;

FIG. 3-7 is an assembled sectional view showing a first condition of a damper of the present invention for a toilet cover plate;

FIG. 3-8 is an assembled sectional view showing a first condition of a damper of the present invention for a toilet cover plate;

FIG. 4-1 is a side view showing a second condition of a damper of the present invention for a toilet cover plate;

FIG. 4-2 is a perspective schematic view showing a second condition of a damper of the present invention for a toilet cover plate;

FIG. 4-3 is a side schematic view showing a second condition of a rotary shaft of a damper of the present invention for a toilet cover plate;

FIG. 4-4 is a side schematic view showing a second condition of a sleeve of a damper of the present invention for a toilet cover plate;

FIG. 4-5 is a sectional schematic view showing a second condition of a combination of a rotary shaft and a sleeve of a damper of the present invention for a toilet cover plate;

FIG. 4-6 is a partially-assembled sectional view showing a second condition of a damper of the present invention for a toilet cover plate;

FIG. 4-7 is an assembled sectional view showing a second condition of a damper of the present invention for a toilet cover plate;

FIG. 4-8 is an assembled sectional view showing a second condition of a damper of the present invention for a toilet cover plate;

FIG. 5-1 is a side view showing a third condition of a damper of the present invention for a toilet cover plate;

FIG. 5-2 is a perspective schematic view showing a third condition of a damper of the present invention for a toilet cover plate;

FIG. 5-3 is a side schematic view showing a third condition of a rotary shaft of a damper of the present invention for a toilet cover plate;

FIG. 5-4 is a side schematic view showing a third condition of a sleeve of a damper of the present invention for a toilet cover plate;

FIG. 5-5 is a sectional schematic view showing a third condition of a combination of a rotary shaft and a sleeve of a damper of the present invention for a toilet cover plate;

FIG. 5-6 is a partially-assembled sectional view showing a third condition of a damper of the present invention for a toilet cover plate;

FIG. 5-7 is an assembled sectional view showing a third condition of a damper of the present invention for a toilet cover plate;

FIG. 5-8 is an assembled sectional view showing a third condition of a damper of the present invention for a toilet cover plate;

FIG. 6-1 is a side view showing a fourth condition of a damper of the present invention for a toilet cover plate;

FIG. 6-2 is a perspective schematic view showing a fourth condition of a damper of the present invention for a toilet cover plate;

FIG. 6-3 is a side schematic view showing a fourth condition of a rotary shaft of a damper of the present invention for a toilet cover plate;

FIG. 6-4 is a side schematic view showing a fourth condition of a sleeve of a damper of the present invention for a toilet cover plate;

FIG. 6-5 is a sectional schematic view showing a fourth condition of a combination of a rotary shaft and a sleeve of a damper of the present invention for a toilet cover plate;

FIG. 6-6 is a partially-assembled sectional view showing a fourth condition of a damper of the present invention for a toilet cover plate;

FIG. 6-7 is an assembled sectional view showing a fourth condition of a damper of the present invention for a toilet cover plate;

FIG. 6-8 is an assembled sectional view showing a fourth condition of a damper of the present invention for a toilet cover plate;

FIG. 7-1 is a side view showing a fifth condition of a damper of the present invention for a toilet cover plate;

FIG. 7-2 is a perspective schematic view showing a fifth condition of a damper of the present invention for a toilet cover plate;

FIG. 7-3 is a side schematic view showing a fifth condition of a rotary shaft of a damper of the present invention for a toilet cover plate;

FIG. 7-4 is a side schematic view showing a fifth condition of a sleeve of a damper of the present invention for a toilet cover plate;

FIG. 7-5 is a sectional schematic view showing a fifth condition of a combination of a rotary shaft and a sleeve of a damper of the present invention for a toilet cover plate;

FIG. 7-6 is a partially-assembled sectional view showing a fifth condition of a damper of the present invention for a toilet cover plate;

FIG. 7-7 is an assembled sectional view showing a fifth condition of a damper of the present invention for a toilet cover plate;

FIG. 7-8 is an assembled sectional view showing a fifth condition of a damper of the present invention for a toilet cover plate;

FIG. 8-1 is a side view showing a sixth condition of a damper of the present invention for a toilet cover plate;

FIG. 8-2 is a perspective schematic view showing a sixth condition of a damper of the present invention for a toilet cover plate;

FIG. 8-3 is a side schematic view showing a sixth condition of a rotary shaft of a damper of the present invention for a toilet cover plate;

FIG. 8-4 is a side schematic view showing a sixth condition of a sleeve of a damper of the present invention for a toilet cover plate;

FIG. 8-5 is a sectional schematic view showing a sixth condition of a combination of a rotary shaft and a sleeve of a damper of the present invention for a toilet cover plate;

FIG. 8-6 is a partially-assembled sectional view showing a sixth condition of a damper of the present invention for a toilet cover plate;

FIG. 8-7 is an assembled sectional view showing a sixth condition of a damper of the present invention for a toilet cover plate;

FIG. 8-8 is an assembled sectional view showing a sixth condition of a damper of the present invention for a toilet cover plate;

FIG. 9-1 is a side view showing a seventh condition of a damper of the present invention for a toilet cover plate;

FIG. 9-2 is a perspective schematic view showing a seventh condition of a damper of the present invention for a toilet cover plate;

FIG. 9-3 is a side schematic view showing a seventh condition of a rotary shaft of a damper of the present invention for a toilet cover plate;

FIG. 9-4 is a side schematic view showing a seventh condition of a sleeve of a damper of the present invention for a toilet cover plate;

FIG. 9-5 is a sectional schematic view showing a seventh condition of a combination of a rotary shaft and a sleeve of a damper of the present invention for a toilet cover plate;

FIG. 9-6 is a partially-assembled sectional view showing a seventh condition of a damper of the present invention for a toilet cover plate;

FIG. 9-7 is an assembled sectional view showing a seventh condition of a damper of the present invention for a toilet cover plate; and

FIG. 9-8 is an assembled sectional view showing a seventh condition of a damper of the present invention for a toilet cover plate.

### DETAILED DESCRIPTION OF THE INVENTION

Hereinafter the present invention is described in detail with reference to the accompanying drawings.

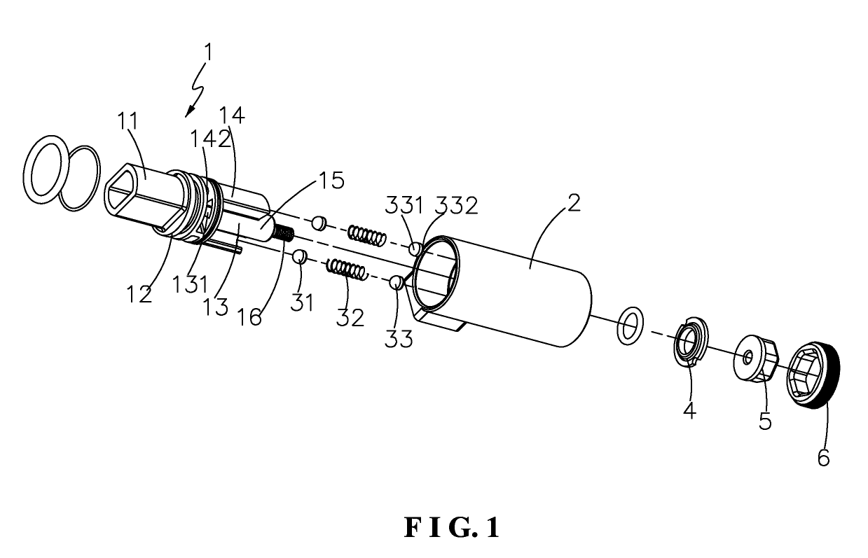

As shown in FIGS. 1, and 2-1 to 2-6, the present invention discloses a damper or damping mechanism, comprising a rotary shaft 1, a sleeve 2 having a cooperating hole 23, damping devices 3, a damping oil, a seal retaining ring 4, a nut 5 and a sleeve-fixing element 6. The seal retaining ring 4, the nut 5 and the sleeve-fixing element 6 constitute a connection member utilized to connect the rotary shaft 1 and the sleeve 2. In this embodiment, the damping mechanism is put in use on a toilet cover plate.

The rotary shaft 1 utilized to fit in the sleeve 2 comprises an inner end passed through a cooperating hole 23 formed on a necking stop wall 22 located in the sleeve 2 and connected by the connection member. A special-shaped fitting part 11 disposed outside the rotary shaft 1 is utilized to engage to the toilet cover plate ‘E’. A flange 12 disposed next to the special-shaped fitting part 11 is utilized to engage with a sealing member, so that the flange 12 and the sleeve 2 are sealingly fitted by the sealing member therebetween. Two symmetrically-formed cooperating grooves 13 disposed next to the flange 12 are extended toward a front part of the rotary shaft 1, and two partition parts 14 are formed between the two cooperating grooves 13. The partition part 14 comprises longitudinally-formed inner chambers 141 utilized to receive the damping devices 3 therein, wherein the inner chamber 141 has an opening at one side thereof communicated with one of the cooperating grooves 13. The two partition parts 14 have a root connected to the flange 12 and providing an oil passing hole 142. The two cooperating grooves 13 have a root connected to the flange 12 and provided with concave grooves 131 communicated with the neighboring oil passing hole 142 of one of the two partition parts 14. The opening of the concave groove 131 is about half the size of a bottom width of the cooperating groove 13. A shrink neck 15, further provided at the front part of the interior of the rotary shaft 1, is utilized to pass through the cooperating hole 23 of the sleeve 2. A thread 16 formed at the front end of the rotary shaft 1 is utilized to engage with the nut 5.

The sleeve 2 comprises an inner wall integrally formed with two centrally-extended spacers 21, and the height of the spacer 21 and the depth of the cooperating groove 13 do match, so that the spacers 21 are respectively located in the cooperating grooves 13. A necking stop wall 22, formed inside the sleeve 2 and provided with the cooperating hole 23, is located at the front end of the spacers 21, and the shrink neck 15 formed at the front part of the interior of the rotary shaft 1 is utilized to pass through the cooperating hole 23 of the necking stop wall 22 of the sleeve 2.

The damping devices 3, respectively received in the inner chambers 141 of the partition part 14, comprises a movable oil-way plugging head 31, a spring 32 and a friction plugging head 33. In this embodiment, the oil-way plugging head 31 can be a spheroid or the oil-way plugging head 31 can be a block which includes one end formed with a plane surface and the other end formed with an arc surface, and the friction plugging head 33 is a block including one end formed with a plane surface and the other end formed with an arc surface.

Certainly, it is applicable that only the oil-way plugging heads 31 are disposed in the inner chambers 141 of the partition part 14, so that the oil-way plugging heads 31 are served as check valves to control the oil passing holes 142 of the partition part 14 make the damping oil flow in a single direction between the two cooperating grooves 13.

In the assembling process, the damping devices 3 are respectively received in the inner chambers 141 of the partition part 14, i.e., the oil-way plugging head 31, the spring 32 and the friction plugging head 33 of the damping device 3 are sequentially disposed in the inner chamber 141 of the partition part 14. The rotary shaft 1 disposed with the damping devices 3 is insertedly disposed in the sleeve 2, the spacers 21 of the sleeve 2 are respectively engaged in the two cooperating grooves 13 of the rotary shaft 1, the outer peripheral walls of the two partition parts 14 are pressed against the inner wall of the sleeve 2, the rear end of the friction plugging head 33 is abutted on the necking stop wall 22 of the sleeve 2, and the arc surface of the oil-way plugging head 31 is fitted in the oil passing hole 142 of the partition part 14. When the shrink neck 15 of the rotary shaft 1 passes through the cooperating hole 23 of the sleeve 2 and the seal retaining ring 4, the thread 16 of the rotary shaft 1 and the nut 5 are connectively locked to each other, the nut 5 and the sleeve 2 are fixedly locked to each other by the sleeve-fixing element 6, and the sleeve-fixing element 6 and the sleeve 2 are connected by toothed ribs which are arranged finely and closely. When the rotary shaft 1 is rotated relative to the sleeve 2, a gap or an oil passing gap ‘L’ formed between the front end surface of the partition part 14 and the necking stop wall 22 of the sleeve 2 is variable followed by a mutual rotation of the rotary shaft 1 and the sleeve 2. The necking stop wall 22 of the sleeve 2 is a sealing end surface utilized to engage with the partition part 14, the damping oil is filled in a closed chamber formed between the rotary shaft 1 and the sleeve 2, and the seal retaining ring 4 is mainly utilized to avoid loosening or fastening the nut 5 caused by the direction friction between the sleeve 2 and the nut 5.

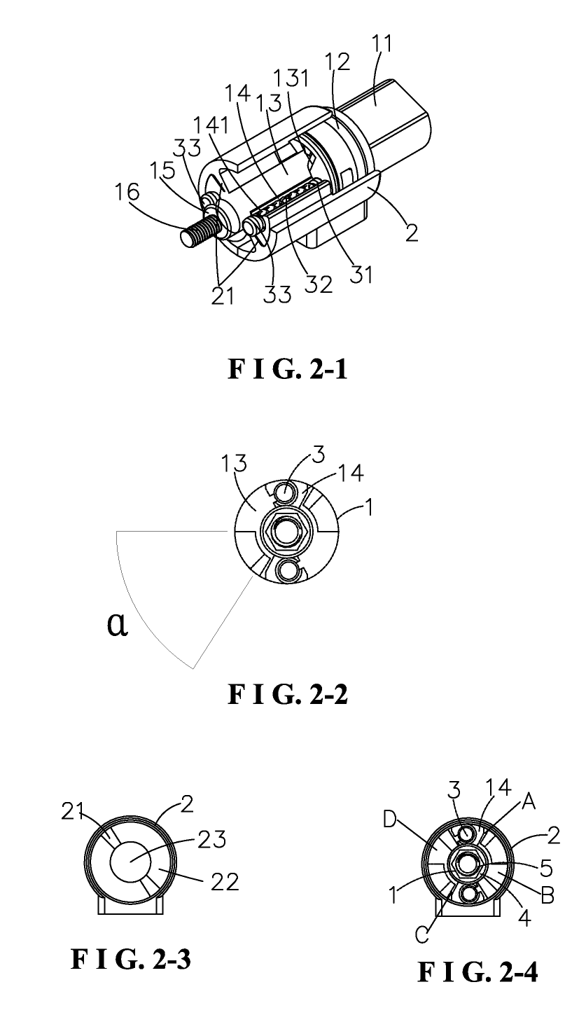

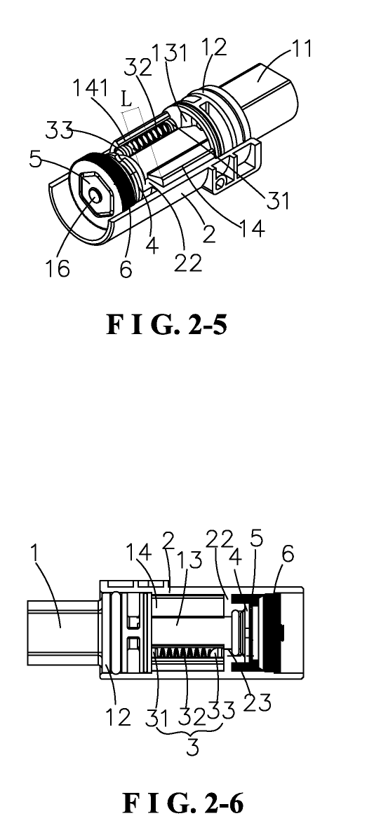

In FIGS. 1, and 2-1 to 2-6, with the two spacers 21 of the sleeve 2, the damper are separated with two isolated chamber bodies therein, i.e., one chamber body is the sum of oil chambers ‘A’ and ‘B’, and the other chamber body is the sum of oil chambers ‘C’ and ‘D’. With the two partition parts 14 of the rotary shaft 1, the chamber bodies divided by the two spacers 21 of the sleeve 2 are separated into two oil ways which are respectively provided for the oil chambers ‘A’/‘B’ and the oil chambers ‘C’/‘D’. With the two cooperating grooves 13 having the root which is connected to the flange 12 and provided with the concave grooves 131, the oil passing amount can be increased when the toilet cover plate ‘E’ is dropping, so that the toilet cover plate is allowed to have a fast-drop process or a so-called ‘hollow angle’ (shown as an angle α in FIG. 2-2); meanwhile, the oil passing amount also can be increased in the lifting process of the toilet cover plate, thereby lifting the toilet cover plate in a labor-saving way. The screwing engagement of the thread 16 of the rotary shaft 1 and the nut 5 realizes the opening and closing of the sealing end surface and the change of the oil passing amount, so that the slow-flowing time of the toilet cover plate can be regulated. Further, due to the pressure of the inner chambers 141 of the partition part 14 being controlled by the filled damping oil, the damping devices 3 received in the inner chambers 141 of the partition part 14 are functioned by the damping oil to drive the oil-way plugging heads 31 for opening and closing the oil passing holes 142 of the partition part 14, thereby efficiently controlling the damping effect of the damping mechanism.

When the toilet cover plate is dropping, the springs 32 of the damping devices 3 tend to press the oil-way plugging heads 31. With the reducing pressure of the damping oil from one inner chamber 141 to the other inner chamber 141, the outward resetting tension force of the springs 32 of the damping devices 3 is increased, i.e., the screwing engagement of the thread 16 of the rotary shaft 1 and the nut 5 drives the rotary shaft 1 to move toward the sleeve 2 to reduce the gap ‘L’ formed between the front end surface of the partition part 14 and the necking stop wall 22 of the sleeve 2, and the spring forces of the springs 32 of the damping devices 3 are increased with the increment of the compression ratio thereof, thereby increasing the friction force formed between the friction plugging head 33 and the necking stop wall 22 of the sleeve 2 to defer the slow-flowing time of the cover plate ‘E’.

The following description is made by taking the operation condition of the upper cover or cover plate ‘E’ of the toilet cover plate relative to a seat pad ‘G’ for example.

[First Condition]

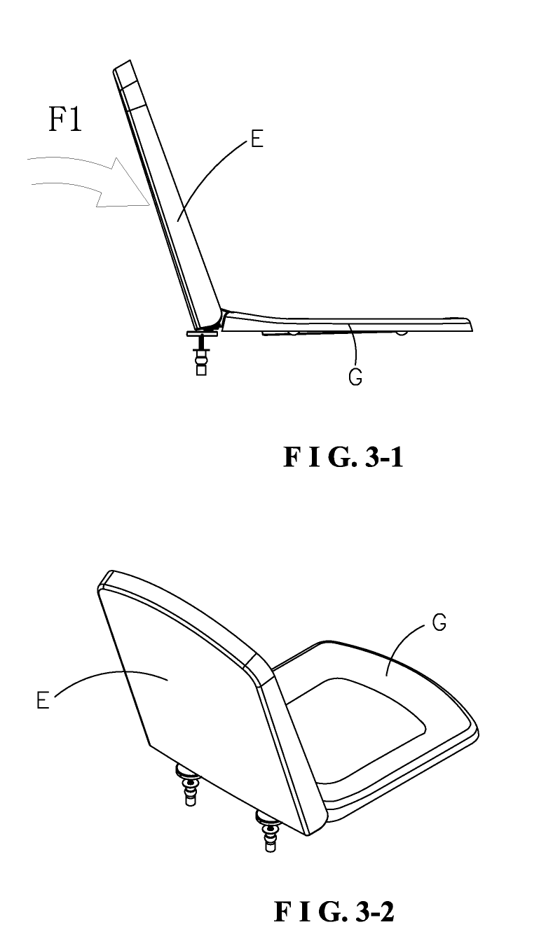

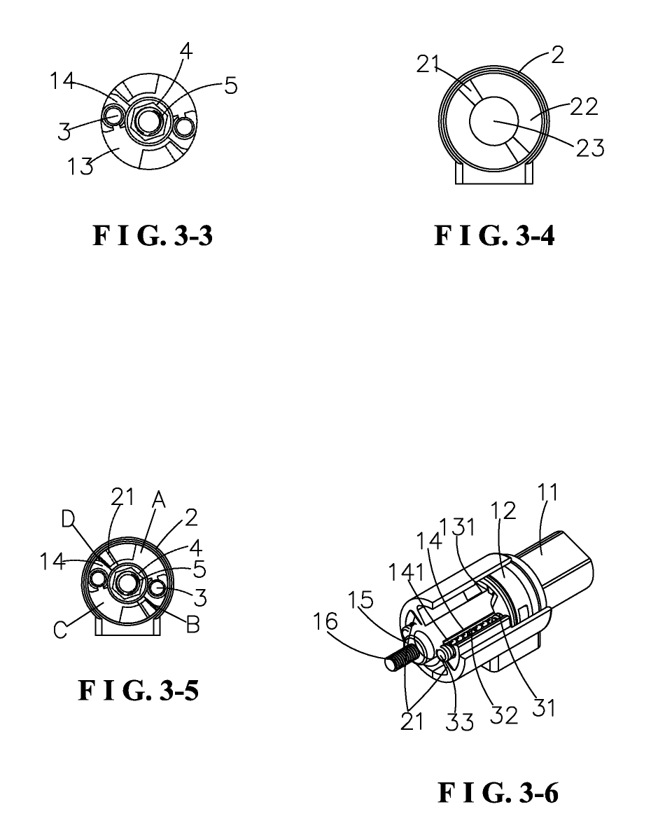

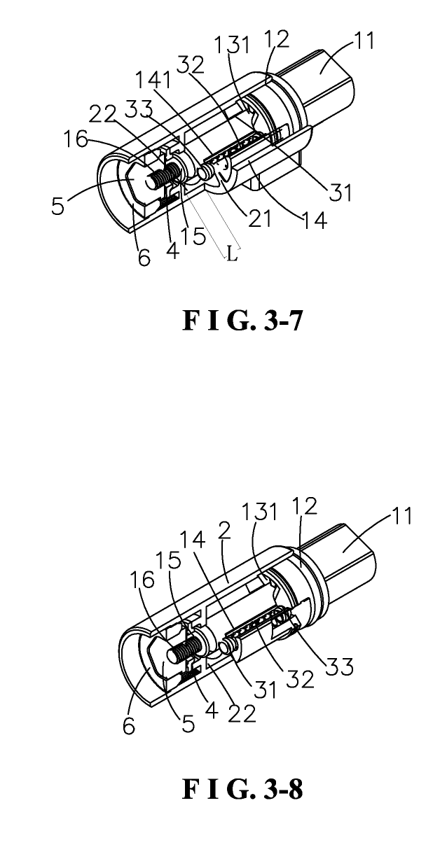

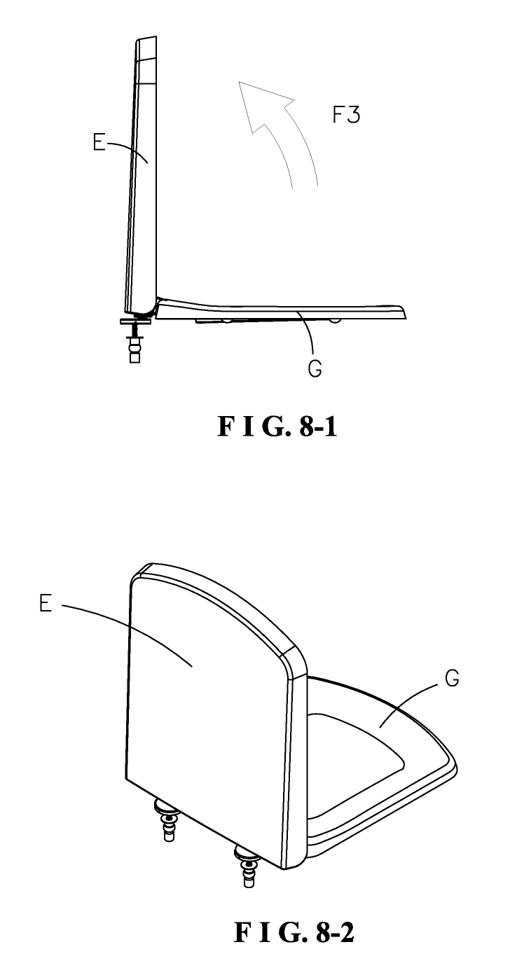

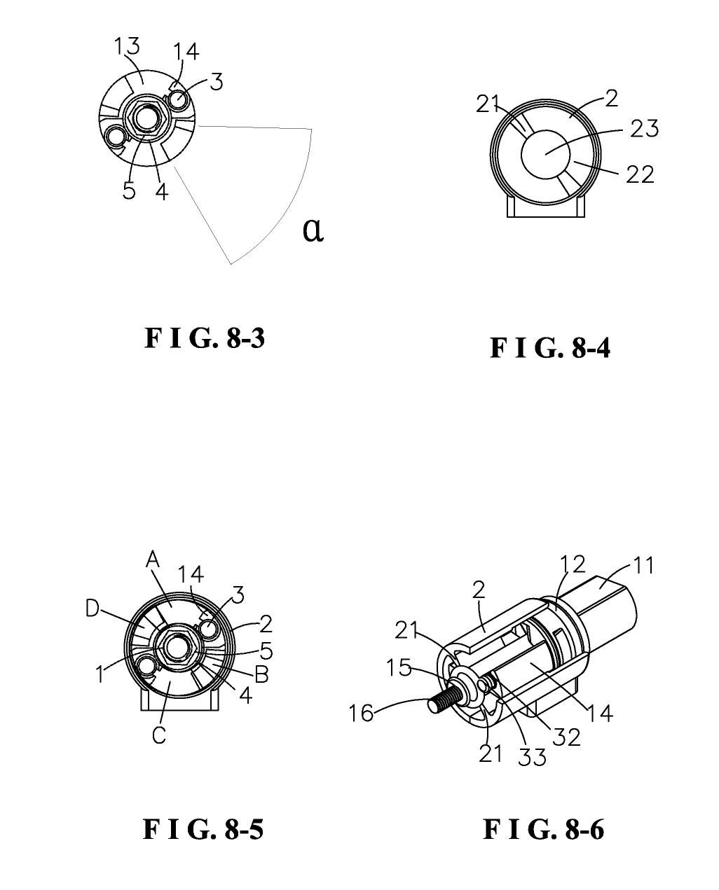

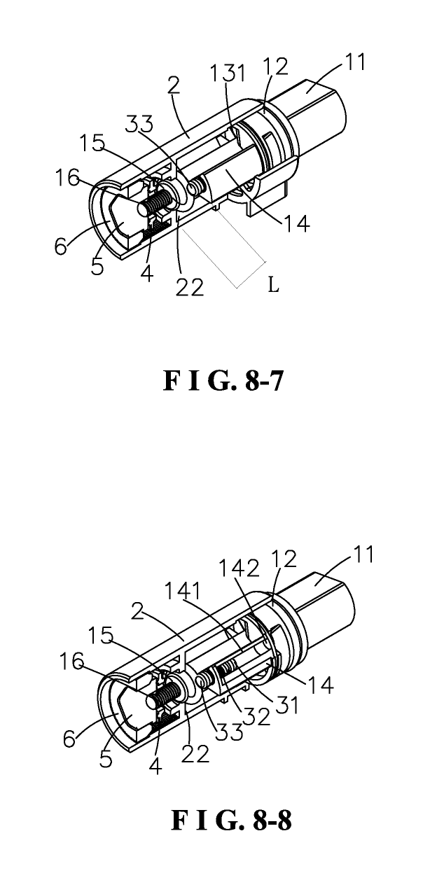

As shown in FIGS. 3-1, 3-2, 3-3, 3-4, 3-5, 3-6, 3-7 and 3-8, the upper cover ‘E’ positioned at a maximum opening angle (FIGS. 3-1 and 3-2), i.e., the upper cover ‘E’ being located near an edge of a toilet tank (not shown in Figs.), is illustrated. In FIG. 3-1, the user can apply a force F1 to drop the upper cover ‘E’. In FIG. 3-5, when the upper cover ‘E’ is dropped, the damping oil entering the oil chamber ‘A’ has a higher pressure than that entering the oil chamber ‘B’, and the springs 32 of the damping devices 3 are provided with the pre-compressed effect, so that the oil passing holes 142 of the partition part 14 of the rotary shaft 1 are blocked by the oil-way plugging heads 31. The damping oil is limited to flow from the oil chamber ‘A’ to the oil chamber ‘B’ via the gap ‘L’ formed between the front end surface of the partition part 14 and the necking stop wall 22 of the sleeve 2 (the oil chambers ‘C’ and ‘D’ working the same principle), and the flux of the damping oil passing the gap ‘L’ therethrough is controlled to overcome the gravity effect of the upper cover ‘E’, thereby realizing a damping function to achieve the slow-flowing effect on the upper cover ‘E’.

[Second Condition]

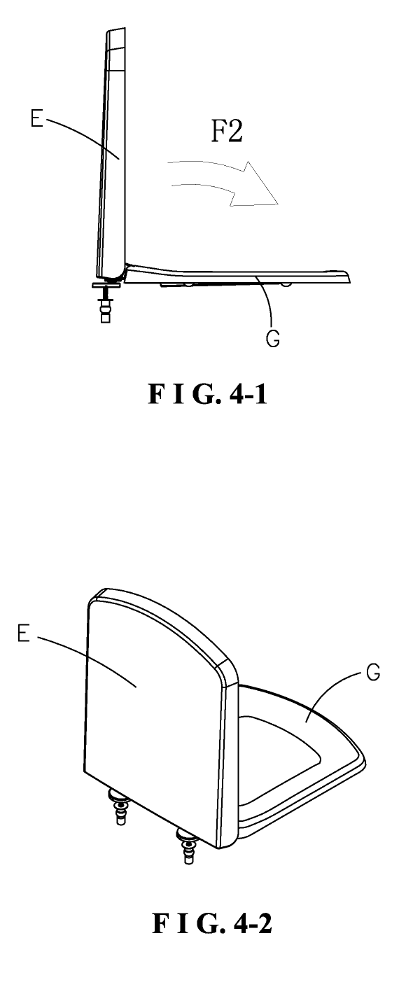

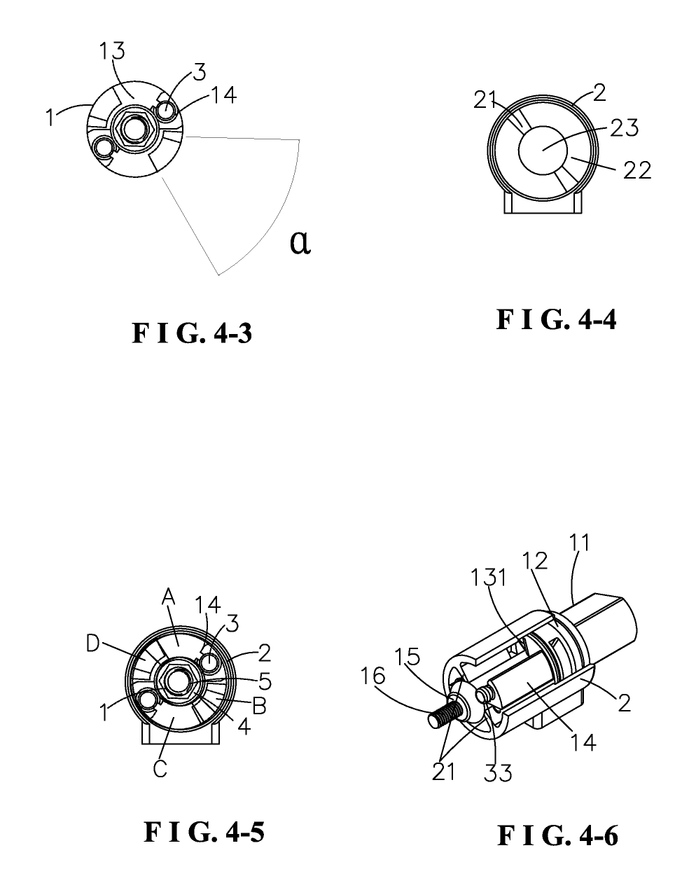

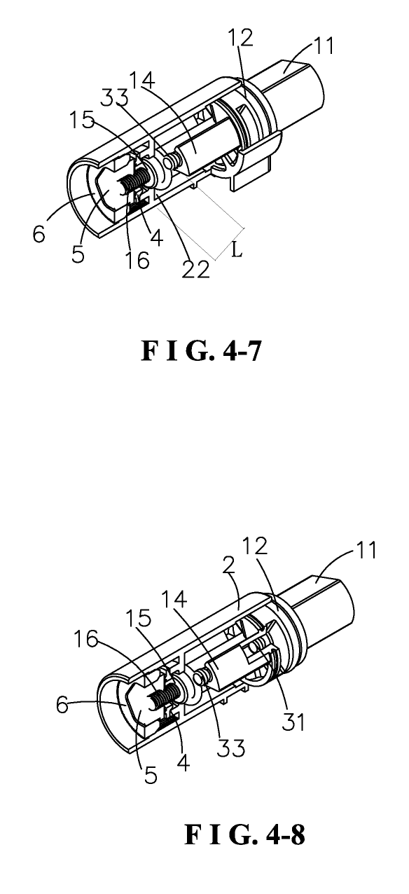

As shown in FIGS. 4-1, 4-2, 4-3, 4-4, 4-5, 4-6, 4-7 and 4-8, the upper cover ‘E’ shifted at a predetermined angle or a so-called ‘angle of empty’ of about 40 degrees in the dropping process is illustrated. In the dropping process of the upper cover ‘E’ functioned by the gravity F2 thereof (see FIG. 4-1), when the spacers 21 of the sleeve 2 are rotated to the positions of the concave grooves 131 of the cooperating grooves 13 of the rotary shaft 1 relative to the rotary shaft 1, the damping oil is allowed passing from the oil chamber ‘C’ to the oil chamber ‘B’ and passing from the oil chamber ‘A’ to the oil chamber ‘D’ to increase the total flux of the damping oil in the damper, so that the upper cover ‘E’ is allowed to be rapidly dropped. Further, with the damping oil entering the oil chamber ‘A’ having a higher pressure than that entering the oil chamber ‘B’ as well as the springs 32 of the damping devices 3 provided with the pre-compressed effect, the oil passing holes 142 of the partition part 14 of the rotary shaft 1 are blocked by the oil-way plugging heads 31. Because the damping oil is limited to flow from the oil chamber ‘A’ to the oil chamber ‘B’ via the gap ‘L’ formed between the front end surface of the partition part 14 and the necking stop wall 22 of the sleeve 2 (the oil chambers ‘C’ and ‘D’ working the same principle), the gap ‘L’ therebetween is decreased when the rotary shaft 1 is rotatably moved toward the sleeve 2 (due to the screwing engagement of the thread 16 of the rotary shaft 1 and the nut 5), and therefore the flux of the damping oil passing through the gap ‘L’ therebetween is relatively decreased.

[Third Condition]

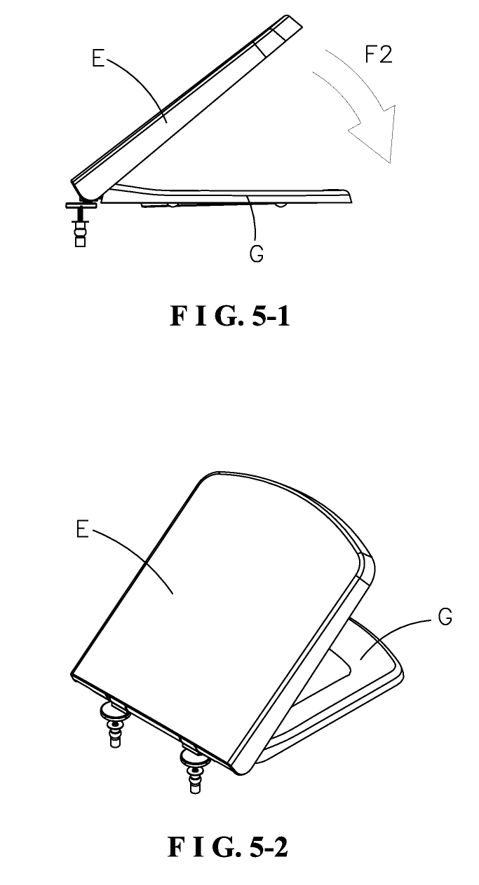

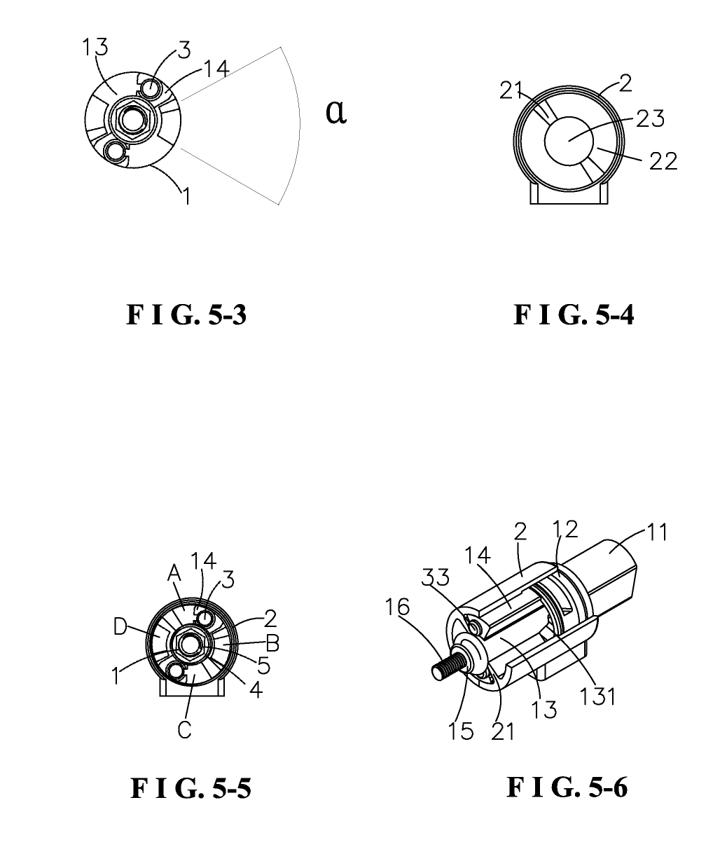

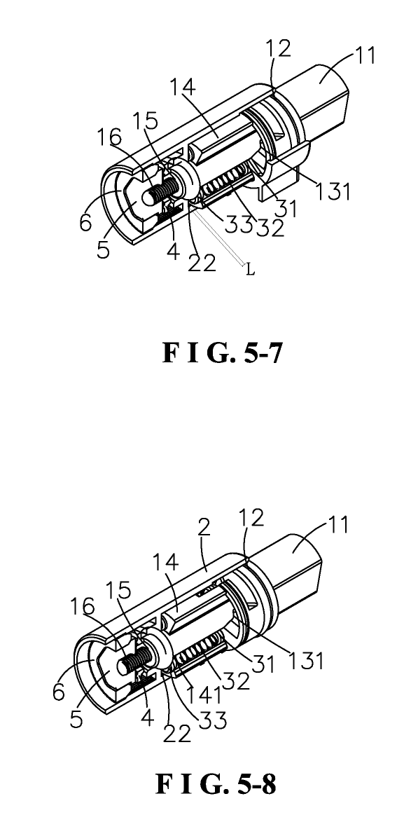

As shown in FIGS. 5-1, 5-2, 5-3, 5-4, 5-5, 5-6, 5-7 and 5-8, the upper cover ‘E’ shifted at a predetermined angle (about 90 degrees) in the dropping process is illustrated. In the dropping process of the upper cover ‘E’ functioned by the gravity F2 thereof (see FIG. 5-1), when the spacers 21 of the sleeve 2 are already rotated over the positions of the concave grooves 131 of the cooperating grooves 13 of the rotary shaft 1 relative to the rotary shaft 1, the damping oil is not allowed passing from the oil chamber ‘C’ to the oil chamber ‘B’ and passing from the oil chamber ‘A’ to the oil chamber ‘D’. With the decreasing of the pressure in the oil chambers ‘A’ and ‘C’, the outward tension force of the springs 32 of the damping devices 3 is increased, thereby increasing the friction force formed between the friction plugging head 33 and the necking stop wall 22 of the sleeve 2 to defer the slow-flowing time of the upper cover ‘E’. Further, because the damping oil entering the oil chamber ‘A’ has a higher pressure than that entering the oil chamber ‘B’ and the springs 32 of the damping devices 3 is provided with the pre-compressed effect, the oil passing holes 142 of the partition part 14 of the rotary shaft 1 are blocked by the oil-way plugging heads 31. Moreover, because the damping oil is limited to flow from the oil chamber ‘A’ to the oil chamber ‘B’ via the gap ‘L’ formed between the front end surface of the partition part 14 and the necking stop wall 22 of the sleeve 2 (the oil chambers ‘C’ and ‘D’ working the same principle), the gap ‘L’ therebetween is decreased when the rotary shaft 1 is rotatably moved toward the sleeve 2 (due to the screwing engagement of the thread 16 of the rotary shaft 1 and the nut 5), thereby decreasing the flux of the damping oil passing through the gap ‘L’ therebetween to cause the upper cover ‘E’ being slowly dropped.

[Fourth Condition]

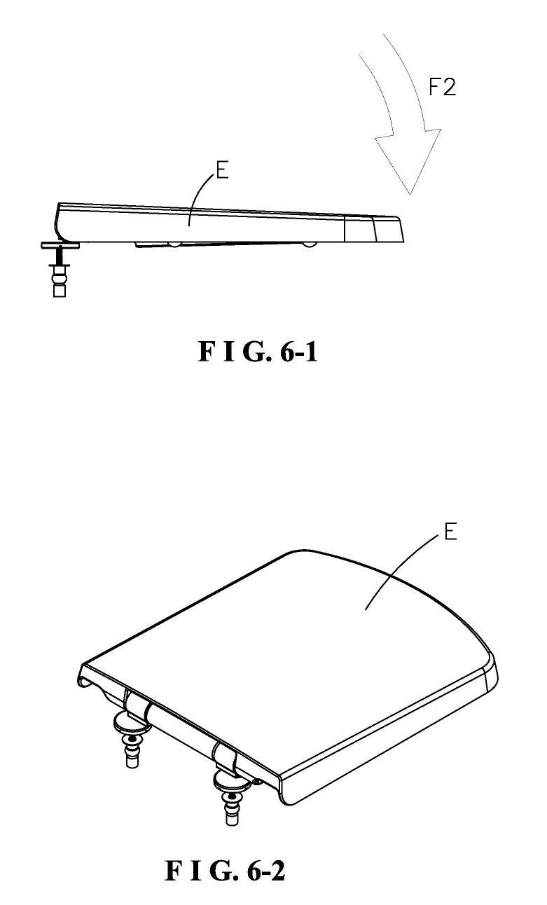

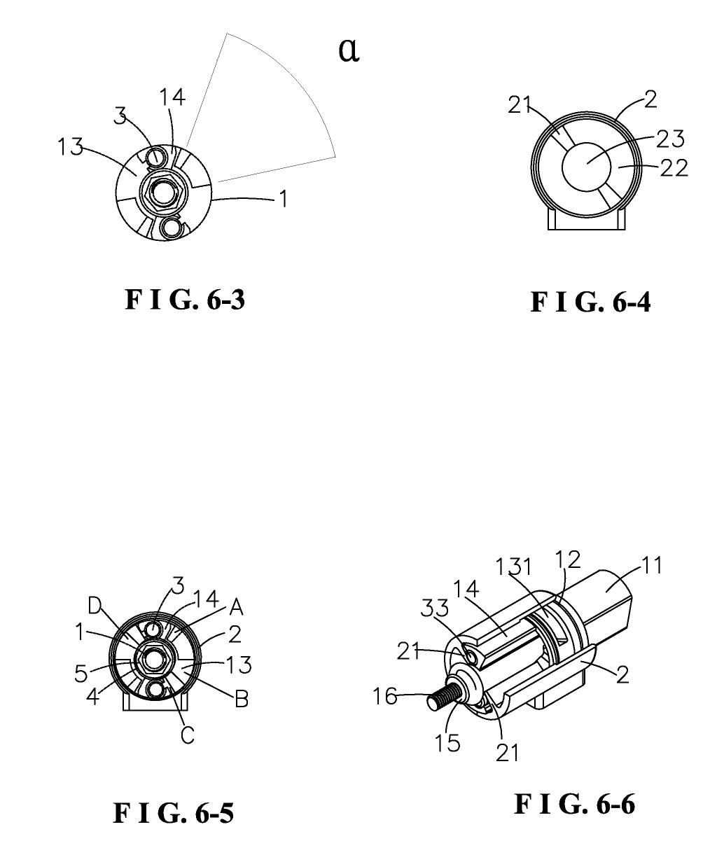

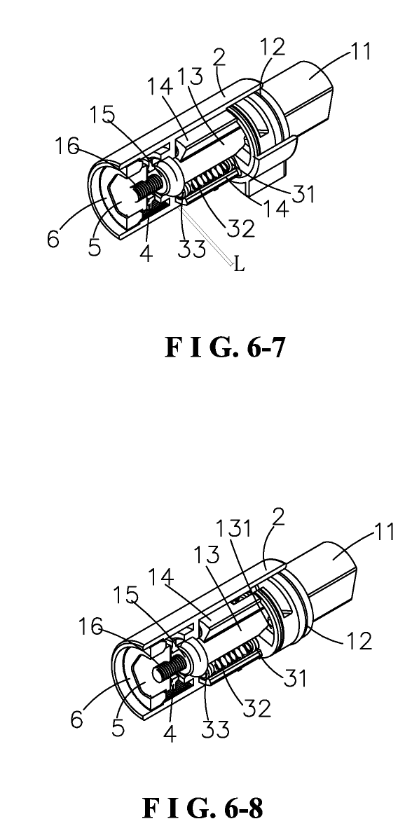

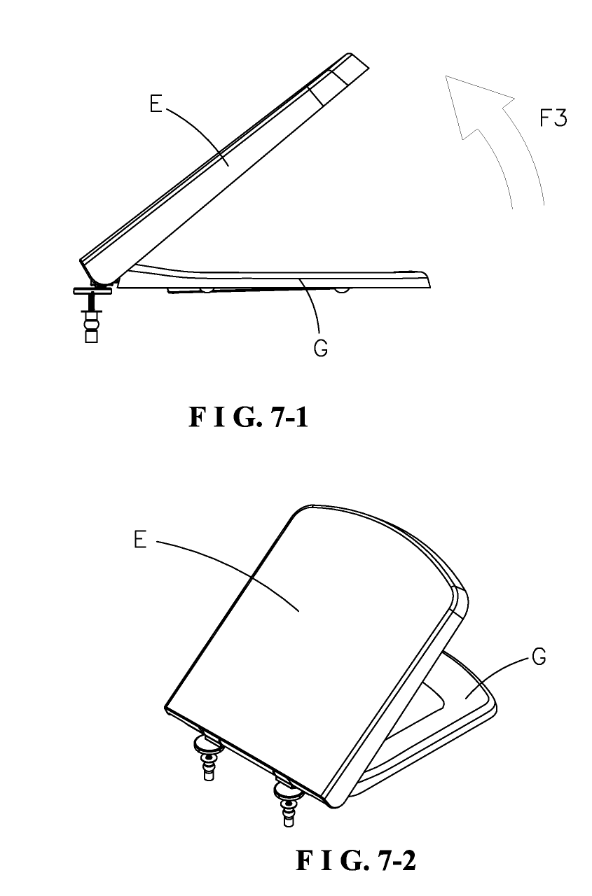

As shown in FIGS. 6-1, 6-2, 6-3, 6-4, 6-5, 6-6, 6-7 and 6-8, the upper cover ‘E’ shifted to a final position (i.e., the upper cover ‘E’ being attached to a plane surface of the toilet) in the dropping process is illustrated. In the dropping process of the upper cover functioned by the gravity F2 thereof (see FIG. 6-1), when the spacers 21 of the sleeve 2 are already rotated over the positions of the concave grooves 131 of the cooperating grooves 13 of the rotary shaft 1 relative to the rotary shaft 1, the damping oil is not allowed passing from the oil chamber ‘C’ to the oil chamber ‘B’ and passing from the oil chamber ‘A’ to the oil chamber ‘D’. With the continuous decreasing of the pressure in the oil chamber ‘A’, the outward tension force of the springs 32 of the damping devices 3 is increased, thereby increasing the friction force formed between the friction plugging head 33 and the necking stop wall 22 of the sleeve 2 to defer the slow-flowing time of the upper cover ‘E’. Further, because the damping oil entering the oil chamber ‘A’ has a higher pressure than that entering the oil chamber ‘B’ and the springs 32 of the damping devices 3 is provided with the pre-compressed effect, the oil passing holes 142 of the partition part 14 of the rotary shaft 1 are blocked by the oil-way plugging heads 31. Moreover, because the damping oil is limited to flow from the oil chamber ‘A’ to the oil chamber ‘B’ via the gap ‘L’ formed between the front end surface of the partition part 14 and the necking stop wall 22 of the sleeve 2 (the oil chambers ‘C’ and ‘D’ working the same principle), the gap ‘L’ therebetween is continuously decreased when the rotary shaft 1 is rotatably moved toward the sleeve 2, thereby decreasing the flux of the damping oil passing through the gap ‘L’ therebetween to cause the upper cover ‘E’ being slowly dropped.

Accordingly, the enhanced gravity effect of the upper cover ‘E’, the decreased flux of the damping oil in the oil chambers ‘A’ and ‘C’, the unobvious damping function and the accelerated slow-flowing time can be obtained when the upper cover ‘E’ is located at the final position (in the final condition). However, because the gap ‘L’ formed between the front end surface of the partition part 14 and the necking stop wall 22 of the sleeve 2 is enlarged and the friction force formed between the friction plugging head 33 and the end surface of the necking stop wall 22 of the sleeve 2 is increased, so that the damping effect is efficiently enhanced to possibly defer the slow-flowing time of the upper cover ‘E’.

Alternatively, it is understood that the damping effect of the damping mechanism can be regulated by increasing the pitch of the threads of the thread 16 of the rotary shaft 1 and the nut 5 or changing the friction coefficient of the friction plugging head 33. In this embodiment, the friction plugging head 33 has one end formed with a plane surface and the other end formed with an arc surface, wherein the end formed with the plane surface has a larger contact friction force than that of the end formed with an arc surface. Therefore, in the actual application, the friction plugging head 33 can have a selectable cooperative end surface according to the size of the required friction force, or the friction plugging head 33 can be selectably made by different materials with controllable friction coefficients, such as Nylon, POM (Polyoxymethylene) or other materials.

[Fifth Condition]

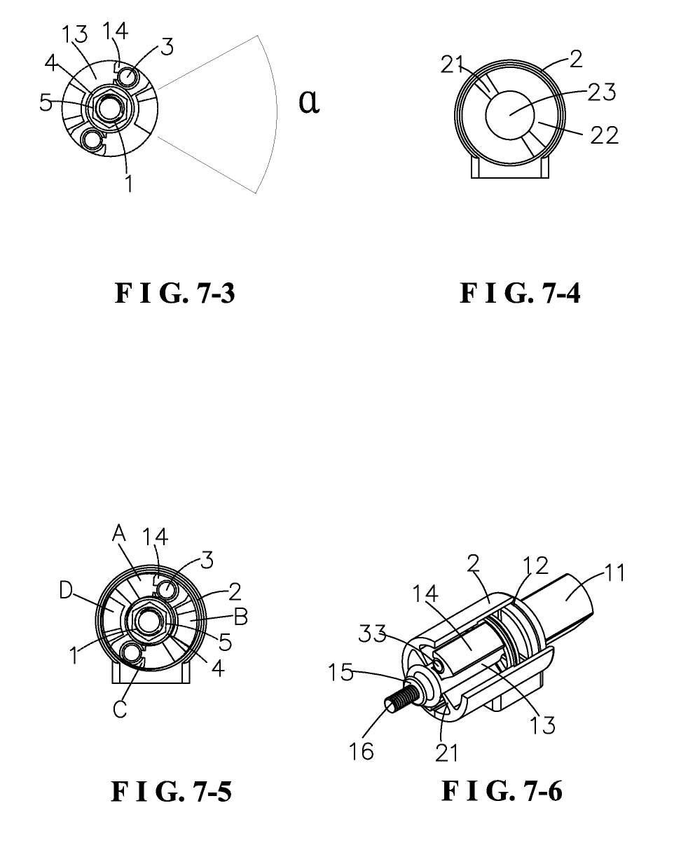

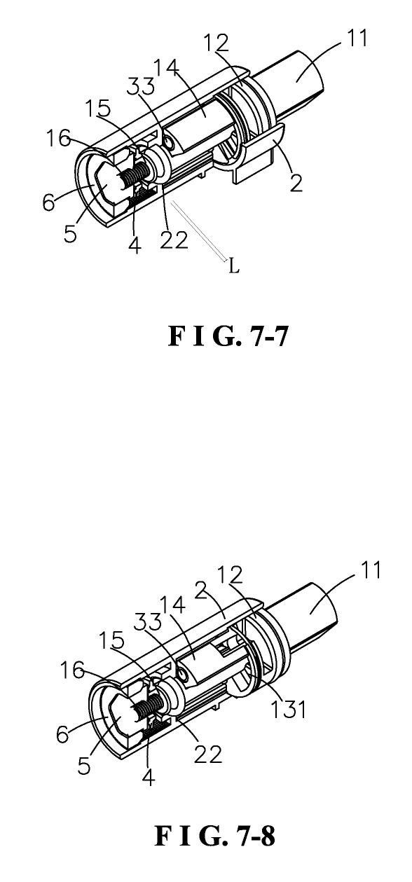

As shown in FIGS. 7-1, 7-2, 7-3, 7-4, 7-5, 7-6, 7-7 and 7-8, the upper cover ‘E’ shifted at a predetermined angle of about 40 degrees in the opening process is illustrated. In the opening process of the upper cover ‘E’, the user uses a force F3 (see FIG. 7-1) to completely overcome the friction force formed between the friction plugging head 33 and the end surface of the necking stop wall 22 of the sleeve 2. With the force F3 being continuously acted on the upper cover ‘E’, the pressure of the damping oil entering the oil chamber ‘B’ is greater than that entering the oil chamber ‘A’ so as to completely overcome the pre-compressed force of the springs 32 of the damping devices 3, the oil passing holes 142 of the partition part 14 of the rotary shaft 1 are opened from the oil-way plugging heads 31 to allow a great quantity of the damping oil entering the oil chamber ‘A’ via the oil chamber ‘B’ (the oil chambers ‘C’ and ‘D’ working the same principle), thus to conveniently lift the upper cover ‘E’. Further, due to the oil-way plugging heads 31 situated in the opening state, part of the damping oil flows from the oil chamber ‘B’ into the oil chamber ‘A’ via the gap ‘L’ formed between the front end surface of the partition part 14 and the necking stop wall 22 of the sleeve 2 (the oil chambers ‘C’ and ‘D’ working the same principle). When the rotary shaft 1 is rotated relative to the nut 5, the rotary shaft 1 is rotatably moved away from the sleeve 2 to increase the gap ‘L’ formed between the front end surface of the partition part 14 and the necking stop wall 22 of the sleeve 2, thereby increasing the oil passing amount passed therethrough.

[Sixth Condition]

As shown in FIGS. 8-1, 8-2, 8-3, 8-4, 8-5, 8-6, 8-7 and 8-8, the upper cover ‘E’ shifted at a predetermined angle of about 90 degrees in the opening process is illustrated. In the lifting process of the upper cover ‘E’ functioned by the force F3 (see FIG. 7-1), when the spacers 21 of the sleeve 2 are rotated to the positions of the concave grooves 131 of the cooperating grooves 13 of the rotary shaft 1 relative to the rotary shaft 1, the damping oil is allowed passing from the oil chamber ‘B’ to the oil chamber ‘C’ and passing from the oil chamber ‘D’ to the oil chamber ‘A’ to increase the total flux of the damping oil in the damper, so that the upper cover ‘E’ is conveniently lifted. With the force F3 being continuously acted on the upper cover ‘E’, the force F3 completely overcomes the friction force formed between the friction plugging head 33 and the end surface of the necking stop wall 22 of the sleeve 2, the pressure of the damping oil entering the oil chamber ‘B’ is greater than that entering the oil chamber ‘A’ so as to completely overcome the pre-compressed force of the springs 32 of the damping devices 3, the oil passing holes 142 of the partition part 14 of the rotary shaft 1 are opened from the oil-way plugging heads 31 to allow a great quantity of the damping oil entering the oil chamber ‘A’ via the oil chamber ‘B’ (the oil chambers ‘C’ and ‘D’ working the same principle), thus to conveniently lift the upper cover ‘E’. Further, due to the oil-way plugging heads 31 situated in the opening state, part of the damping oil flows from the oil chamber ‘B’ into the oil chamber ‘A’ via the gap ‘L’ formed between the front end surface of the partition part 14 and the necking stop wall 22 of the sleeve 2 (the oil chambers ‘C’ and ‘D’ working the same principle). When the rotary shaft 1 is rotated relative to the nut 5, the rotary shaft 1 is rotatably moved away from the sleeve 2 to increase the gap ‘L’ formed between the front end surface of the partition part 14 and the necking stop wall 22 of the sleeve 2, thereby increasing the oil passing amount passed therethrough.

[Seventh Condition]

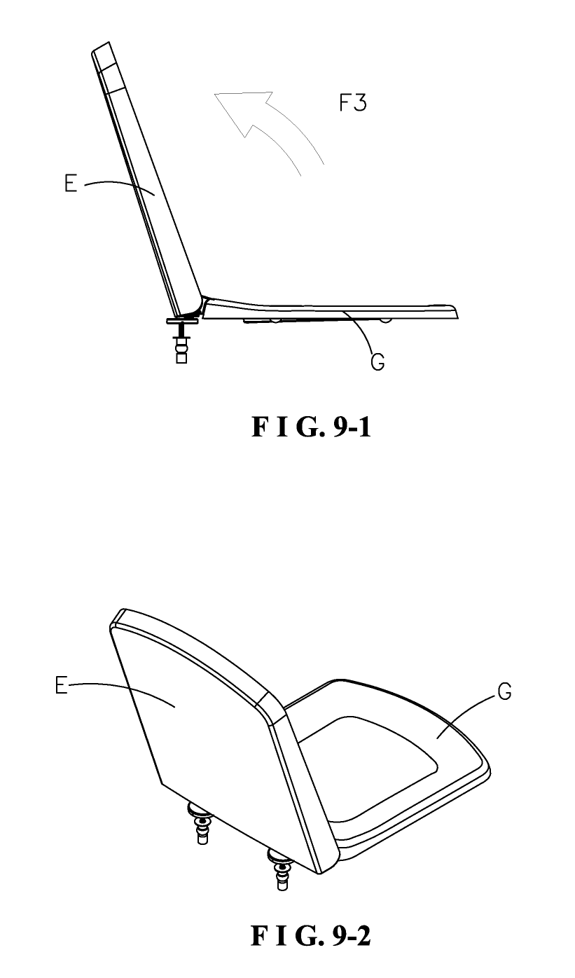

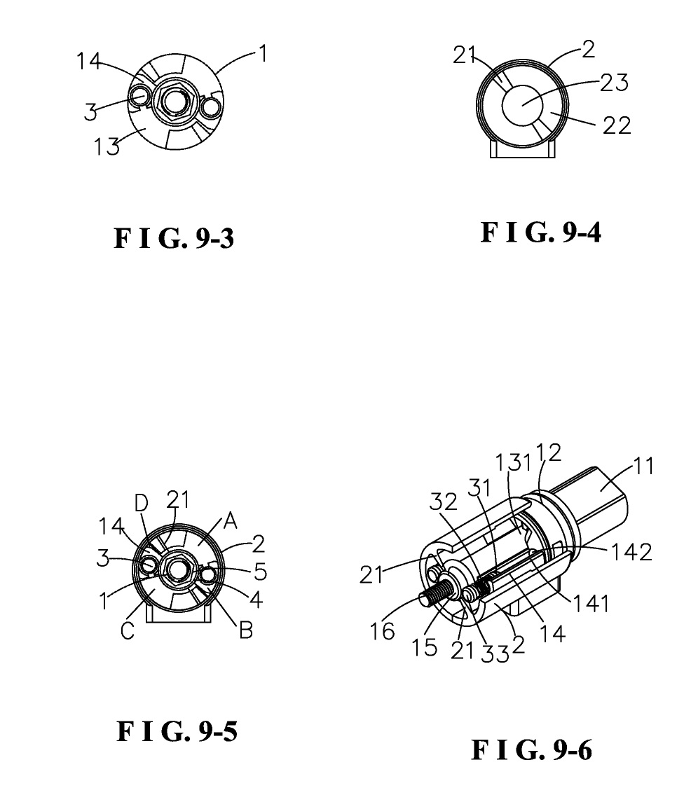

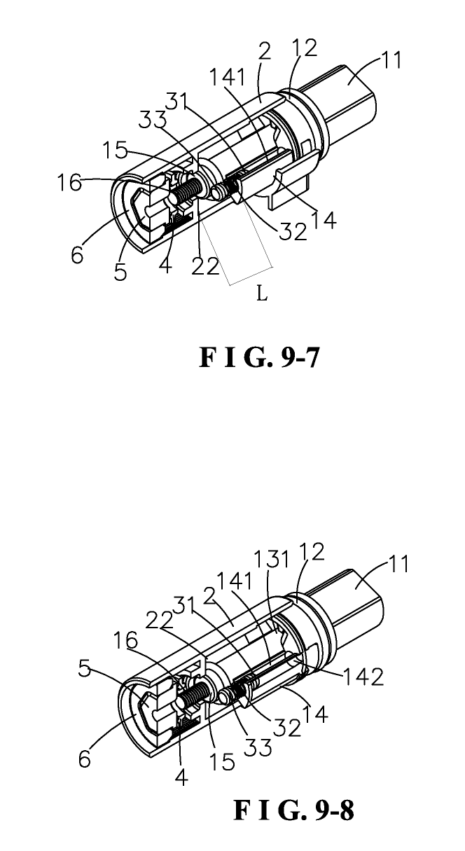

As shown in FIGS. 9-1, 9-2, 9-3, 9-4, 9-5, 9-6, 9-7 and 9-8, the upper cover ‘E’ positioned at the maximum opening angle (FIGS. 9-1 and 9-2), i.e., the upper cover ‘E’ being located near the edge of the toilet tank (not shown in Figs.), is illustrated. In the lifting process of the upper cover ‘E’ functioned by the force F3 (see FIG. 9-1), when the spacers 21 of the sleeve 2 are rotated to the positions of the concave grooves 131 of the cooperating grooves 13 of the rotary shaft 1 relative to the rotary shaft 1, the damping oil is allowed passing from the oil chamber ‘B’ to the oil chamber ‘C’ and passing from the oil chamber ‘D’ to the oil chamber ‘A’ to increase the total flux of the damping oil in the damper, so that the upper cover ‘E’ is conveniently lifted. With the force F3 being continuously acted on the upper cover ‘E’, the force F3 completely overcomes the friction force formed between the friction plugging head 33 and the end surface of the necking stop wall 22 of the sleeve 2, the pressure of the damping oil entering the oil chamber ‘B’ is greater than that entering the oil chamber ‘A’ so as to completely overcome the pre-compressed force of the springs 32 of the damping devices 3, the oil passing holes 142 of the partition part 14 of the rotary shaft 1 are opened from the oil-way plugging heads 31 to allow a great quantity of the damping oil entering the oil chamber ‘A’ via the oil chamber ‘B’ (the oil chambers ‘C’ and ‘D’ working the same principle), thus to conveniently lift the upper cover ‘E’. Further, due to the oil-way plugging heads 31 situated in the opening state, part of the damping oil flows from the oil chamber ‘B’ into the oil chamber ‘A’ via the gap ‘L’ formed between the front end surface of the partition part 14 and the necking stop wall 22 of the sleeve 2 (the oil chambers ‘C’ and ‘D’ working the same principle). When the rotary shaft 1 is rotated relative to the nut 5, the rotary shaft 1 is rotatably moved away from the sleeve 2 to increase the gap ‘L’ formed between the front end surface of the partition part 14 and the necking stop wall 22 of the sleeve 2, thereby increasing the oil passing amount passed therethrough.

It is understood that, in the final lifting process, the gravity effect of the upper cover ‘E’ is aggravated. However, because of the upper cover ‘E’ still being continuously functioned by the force F3 to gradually reduce the volume of the damping oil in the oil chambers ‘B’ and ‘D’, the oil passing effect being efficiently enhanced by the increase of the gap ‘L’ formed between the front end surface of the partition part 14 and the necking stop wall 22 of the sleeve 2, and the reduce of the friction force formed between the friction plugging head 33 and the necking stop wall 22 of the sleeve 2, the upper cover ‘E’ still can be conveniently lifted.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A damper, comprising a rotary shaft, a sleeve, a damping oil, and a connection member connecting the rotary shaft and the sleeve, the damping oil being filled in a closed chamber formed between the rotary shaft and the sleeve, it is characterized in that two cooperating grooves are symmetrically formed on the rotary shaft, two partition parts are formed between the two cooperating grooves, each of the partition parts comprises a root providing an oil passing hole communicated with the two cooperating grooves, the oil passing hole of the partition part is controlled by a check valve so as to make the damping oil flow in a single direction between the two cooperating grooves, the rotary shaft comprises an inner end passed through a cooperating hole formed on a necking stop wall located in the sleeve and connected by the connection member, the sleeve comprises an inner wall integrally formed with two centrally-extended spacers, the height of the spacer and the depth of the cooperating groove do match so that the spacers are respectively located in the cooperating grooves, and an oil passing gap formed between the rotary shaft and the sleeve is variable followed by a mutual rotation of the rotary shaft and the sleeve.

2. The damper as claimed in claim 1, characterized in that the check valve is a movable oil-way plugging head disposed in a longitudinally-formed inner chamber of the partition part, and the inner chamber of the partition part comprises an opening at one side thereof communicated with the cooperating grooves.

3. The damper as claimed in claim 2, characterized in that the damper further comprises a friction plugging head disposed in the inner chamber of the partition part and a spring disposed between the movable oil-way plugging head and the friction plugging head, the movable oil-way plugging head is engaged to the oil passing hole of the partition part, and the friction plugging head is contacted by an end surface of the necking stop wall located in the sleeve.

4. The damper as claimed in claim 1, characterized in that the connection member comprises a seal retaining ring, a nut pressed against the seal retaining ring, and a sleeve-fixing element fixed on the sleeve, the nut is engaged to the rotary shaft passed through the cooperating hole of the sleeve, a plurality of toothed ribs being arranged finely and closely are connected between the sleeve-fixing element and the sleeve, a special-shaped fitting part disposed outside the rotary shaft is utilized to engage to a cover plate, a flange disposed next to the special-shaped fitting part is utilized to engage with a sealing member so that the flange and the sleeve are sealingly fitted by the sealing member therebetween, and the two symmetrically-formed cooperating grooves are disposed next to the flange and extended toward a front part of the rotary shaft.

5. The damper as claimed in claim 1, characterized in that the root of each of the partition parts includes a concave groove communicated with the neighboring oil passing hole of one of the two partition parts, and an opening of the concave groove is about half the size of a bottom width of the cooperating groove.

6. The damper as claimed in claim 2, characterized in that the movable oil-way plugging head comprises a spheroid.

7. The damper as claimed in claim 2 or 3, characterized in that the movable oil-way plugging head comprises a block including one end formed with a plane surface and the other end formed with an arc surface.

8. The damper as claimed in claim 3, characterized in that the friction plugging head comprises a block including one end formed with a plane surface and the other end formed with an arc surface.

9. The damper as claimed in claim 3, characterized in that the friction plugging head comprises a plane surface contacted by the end surface of the necking stop wall located in the sleeve.

10. The damper as claimed in claim 3, characterized in that the friction plugging head comprises a arc surface contacted by the end surface of the necking stop wall located in the sleeve.
